(19) United States
(12) Patent Application Publication
(10) Pub. No.: US 2025/0317367 A1
(43) Pub. Date: Oct. 9, 2025

(54) VISUALIZATION FOR NETWORK SERVICES AND THEIR RELATIONSHIPS WITH END-USERS, SERVICE LOCATIONS, AND OTHER NETWORK SERVICES

(71) Applicant: Level 3 Communications, LLC, Denver, CO (US)

(72) Inventors: Gurpreet S. Sidhu, Aurora, CO (US); Mark Alan Ramach, Seattle, WA (US); Priyadarshini Dande, Thornton, CO (US)

(73) Assignee: Level 3 Communications, LLC, Denver, CO (US)

(21) Appl. No.: 19/049,563

(22) Filed: Feb. 10, 2025

Related U.S. Application Data
(60) Provisional application No. 63/573,832, filed on Apr. 3, 2024.

(51) Int. Cl. H04L 41/22; G06F 3/04842; G06F 3/04845; G06T 11/20; H04L 9/40

(52) U.S. Cl. CPC H04L 41/22; G06F 3/04842; G06F 3/04845; G06T 11/206; H04L 63/102; G06F 2203/04806

(57) ABSTRACT

Novel tools and techniques are provided for implementing visualization for network services and their relationships with end-users, service locations, and other network services. In various examples, a computing system may collect, from one or more databases, information regarding one or more network services provided by a service provider. The information may include at least one of end-user information, service-specific information, service location information, or contact information, and/or the like. The computing system may identify information objects and their relationships by analyzing the collected information. The computing system may generate a graphical representation of the information objects and their relationships, and may generate a user interface (“UI”) for presenting the generated graphical representation, and may display, on a display screen of a user device, the UI to a user.

### CROSS-REFERENCE TO RELATED APPLICATIONS

This application claims the benefit of U.S. Provisional Application No. 63/573,832 filed Apr. 3, 2024, entitled “Visualization for Network Services and Their Relationships with End-Users, Service Locations, and Other Network Services,” which is incorporated herein by reference in its entirety.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### FIELD

The present disclosure relates, in general, to methods, systems, and apparatuses for implementing provisioning of network services (including secure access service edge (“SASE”) services), and, more particularly, to methods, systems, and apparatuses for implementing visualization for network services and their relationships with end-users, service locations, and other network services.

### BACKGROUND

Typical network service provisioning is provided on a service-by-service basis, where even services to a single customer may not be collated within a single dashboard or view for a customer, a service provider agent, or a technician. Typical network service provisioning also does not provide an overall graphical view of all network services provided to a customer, much less provide an overall graphical view of the network services provisioned to multiple customers over common networks or across similar services and their associated relationships. It is with respect to this general technical environment to which aspects of the present disclosure are directed.

### BRIEF DESCRIPTION OF THE DRAWINGS

A further understanding of the nature and advantages of particular embodiments may be realized by reference to the remaining portions of the specification and the drawings, which are incorporated in and constitute a part of this disclosure.

FIG. 1 depicts an example system for implementing visualization for network services and their relationships with end-users, service locations, and other network services, in accordance with various embodiments.

FIGS. 2A and 2B depict various example user interfaces for a user portal or a UX platform that may be used when implementing visualization for network services and their relationships with end-users, service locations, and other network services, in accordance with various embodiments.

FIG. 3 depicts an example user interface for a user portal or a UX platform that may be used when implementing visualization for network services (including SASE services) and their relationships with end-users, service locations, and other network services, in accordance with various embodiments.

FIGS. 4A-4C depict flow diagrams illustrating an example method for implementing visualization for network services and their relationships with end-users, service locations, and other network services, in accordance with various embodiments.

FIG. 5 depicts a block diagram illustrating an exemplary computer or system hardware architecture, in accordance with various embodiments.

### DETAILED DESCRIPTION OF CERTAIN EMBODIMENTS

### Overview

In various examples, a computing system may collect, from one or more databases, information regarding one or more network services provided by a service provider. The information may include at least one of end-user information, service-specific information, service location information, or contact information, and/or the like. The computing system may identify information objects and their relationships by analyzing the collected information. The computing system may generate a graphical representation of the information objects and their relationships, and may generate a user interface (“UI”) for presenting the generated graphical representation, and may display, on a display screen of a user device, the UI to a user.

In this manner, the system may implement a single interface or portal on which visualization (i.e., an overall graphical view) of network services and their relationships with end-users, service locations, and other network services. In examples, network services including secure access service edge (“SASE”) services may be displayed within the UI or portal (in some cases, displayed within a user experience (“UX”) platform) as nodes together with their relationships to the end-users or customers, service locations, contacts, and/or other network services. This provides a user with a consolidated view of the network services and their relationships.

These and other aspects of the visualization for network services and their relationships with end-users, service locations, and other network services are described in greater detail with respect to the figures.

The following detailed description illustrates a few exemplary embodiments in further detail to enable one of skill in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art, however, that other embodiments of the present invention may be practiced without some of these specific details. In other instances, certain structures and devices are shown in block diagram form. Several embodiments are described herein, and while various features are ascribed to different embodiments, it should be appreciated that the features described with respect to one embodiment may be incorporated with other embodiments as well. By the same token, however, no single feature or features of any described embodiment should be considered essential to every embodiment of the invention, as other embodiments of the invention may omit such features.

In this detailed description, wherever possible, the same reference numbers are used in the drawing and the detailed description to refer to the same or similar elements. In some instances, a sub-label is associated with a reference numeral to denote one of multiple similar components. When reference is made to a reference numeral without specification to an existing sub-label, it is intended to refer to all such multiple similar components. In some cases, for denoting a plurality of components, the suffixes “a” through “n” may be used, where n denotes any suitable non-negative integer number (unless it denotes the number 14, if there are components with reference numerals having suffixes “a” through “m” preceding the component with the reference numeral having a suffix “n”), and may be either the same or different from the suffix “n” for other components in the same or different figures. For example, for component #1 X05a-X05n, the integer value of n in X05n may be the same or different from the integer value of n in X10n for component #2 X10a-X10n, and so on. In other cases, other suffixes (e.g., s, t, u, v, w, x, y, and/or z) may similarly denote non-negative integer numbers that (together with n or other like suffixes) may be either all the same as each other, all different from each other, or some combination of same and different (e.g., one set of two or more having the same values with the others having different values, a plurality of sets of two or more having the same value with the others having different values, etc.).

Unless otherwise indicated, all numbers used herein to express quantities, dimensions, and so forth used should be understood as being modified in all instances by the term “about.” In this application, the use of the singular includes the plural unless specifically stated otherwise, and use of the terms “and” and “or” means “and/or” unless otherwise indicated. Moreover, the use of the term “including,” as well as other forms, such as “includes” and “included,” should be considered non-exclusive. Also, terms such as “element” or “component” encompass both elements and components including one unit and elements and components that include more than one unit, unless specifically stated otherwise.

Aspects of the present invention, for example, are described below with reference to block diagrams and/or operational illustrations of methods, systems, and computer program products according to aspects of the invention. The functions and/or acts noted in the blocks may occur out of the order as shown in any flowchart. For example, two blocks shown in succession may in fact be executed substantially concurrently or the blocks may sometimes be executed in the reverse order, depending upon the functionalities and/or acts involved. Further, as used herein and in the claims, the phrase “at least one of element A, element B, or element C” (or any suitable number of elements) is intended to convey any of: element A, element B, element C, elements A and B, elements A and C, elements B and C, and/or elements A, B, and C (and so on).

The description and illustration of one or more aspects provided in this application are not intended to limit or restrict the scope of the invention as claimed in any way. The aspects, examples, and details provided in this application are considered sufficient to convey possession and enable others to make and use the best mode of the claimed invention. The claimed invention should not be construed as being limited to any aspect, example, or detail provided in this application. Regardless of whether shown and described in combination or separately, the various features (both structural and methodological) are intended to be selectively rearranged, included, or omitted to produce an example or embodiment with a particular set of features. Having been provided with the description and illustration of the present application, one skilled in the art may envision variations, modifications, and alternate aspects, examples, and/or similar embodiments falling within the spirit of the broader aspects of the general inventive concept embodied in this application that do not depart from the broader scope of the claimed invention.

In an aspect, the technology relates to a method including collecting, by a computing system and from one or more databases, information regarding one or more network services provided by a service provider, the information including at least one of end-user information, service-specific information, service location information, or contact information; identifying, by the computing system, information objects and their relationships by analyzing the collected information; generating, by the computing system, a graphical representation of the information objects and their relationships; generating, by the computing system, a UI for presenting the generated graphical representation; and displaying, by the computing system and on a display screen of a user device, the UI to a user.

In another aspect, the technology relates to a system including a computing system including a processing system and memory coupled to the processing system. The memory includes computer executable instructions that, when executed by the processing system, causes the system to perform operations including: generating a graphical representation of information objects and their relationships based on analysis of collected information regarding one or more network services provided by a service provider, wherein the one or more network services include SASE services; generating a UI for presenting the generated graphical representation; displaying, on a display screen of a user device, the UI to a user; receiving user input from the user corresponding to interactions with at least one of one or more information objects or one or more relationships within the displayed UI; generating an updated graphical representation of the information objects and their relationships based on the interactions; generating an updated UI for presenting the generated updated graphical representation; and displaying, on the display screen of the user device, the updated UI to the user.

In yet another aspect, the technology relates to a method including providing, by a computing system, a UX platform for a customer portal, the UX platform being accessible by a user via a user device over one or more first networks; generating, by the computing system, a graphical representation of information objects and their relationships based on analysis of collected information regarding one or more network services provided by a service provider and further based on access permissions of the user; generating, by the computing system, a UI for presenting the generated graphical representation within the UX platform; displaying, by the computing system and on a display screen of the user device, the UI to the user; receiving, by the computing system and from the user device, user input corresponding to interactions with at least one of one or more information objects or one or more relationships within the generated and displayed UI; generating, by the computing system, an updated graphical representation of the information objects and their relationships based on the interactions; generating, by the computing system, an updated UI for presenting the generated updated graphical representation; and displaying, by the computing system and on the display screen of the user device, the updated UI to the user.

Various modifications and additions can be made to the embodiments discussed without departing from the scope of the invention. For example, while the embodiments described above refer to particular features, the scope of this invention also includes embodiments having different combination of features and embodiments that do not include all of the above-described features.

### Specific Exemplary Embodiments

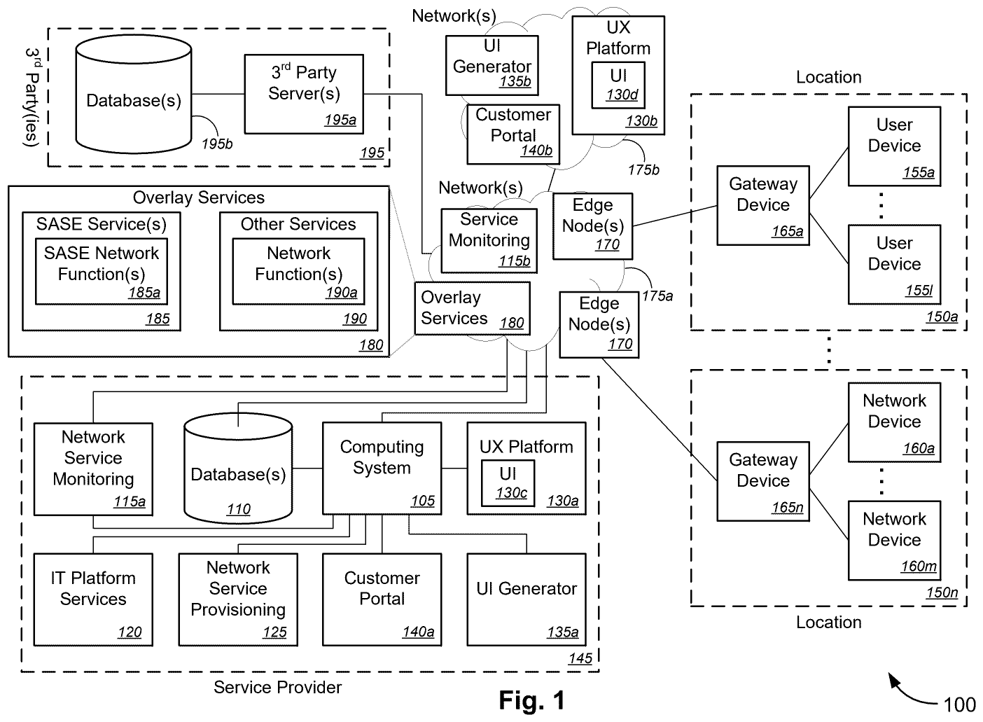

We now turn to the embodiments as illustrated by the drawings. FIGS. 1-5 illustrate some of the features of the method, system, and apparatus for implementing provisioning of network services (including secure access service edge (“SASE”) services), and, more particularly, to methods, systems, and apparatuses for implementing visualization for network services and their relationships with end-users, service locations, and other network services, as referred to above. The methods, systems, and apparatuses illustrated by FIGS. 1-5 refer to examples of different embodiments that include various components and steps, which can be considered alternatives or which can be used in conjunction with one another in the various embodiments. The description of the illustrated methods, systems, and apparatuses shown in FIGS. 1-5 is provided for purposes of illustration and should not be considered to limit the scope of the different embodiments.

With reference to the figures, FIG. 1 depicts an example system 100 for implementing visualization for network services and their relationships with end-users, service locations, and other network services, in accordance with various embodiments.

In the non-limiting embodiment of FIG. 1, system 100 may include computing system 105, database(s) 110, network service monitoring system 115a, information technology (“IT”) platform services 120, network service provisioning system 125, user experience (“UX”) platform system 130a, user interface (“UI”) generator 135a, and customer portal 140a, each associated with a service provider 145. In some embodiments, disposed within locations 150a-150n (collectively, “locations 150” or the like), each associated with a user, may be one or more user devices 155a-155l (collectively, “user devices 155” or the like) and/or one or more network devices 160a-160m (collectively, “network devices 160” or the like), each communicatively coupled to one of gateway devices 165a-165n (collectively, “gateway devices 165” or the like). In some instances, the user may include one of a customer of the service provider, a call agent of service provider, a technician of the service provider, a NOC engineer, an agent of a third party network provider, an agent of a third party service provider, and/or the like. In some cases, each of the third party network provider and the third party service provider is separate from the service provider providing the one or more network services. Herein, l, m, and n are non-negative integer numbers that may be either all the same as each other, all different from each other, or some combination of same and different (e.g., one set of two or more having the same values with the others having different values, a plurality of sets of two or more having the same value with the others having different values, etc.).

System 100 may further include one or more edge nodes 170 disposed in one or more networks 175a, which may be operated or provided by service provider 145 or a different service provider (not shown). According to some embodiments, alternative or additional to at least one of UX platform system 130a, UI generator 135a, and/or customer portal 140a, system 100 may (further) include corresponding at least one of UX platform system 130b, UI generator 135b, and/or customer portal 140b disposed within network(s) 175b, which may be associated with a different service provider compared with the service provider 145 and/or the service provider for operating or providing the one or more networks 175a and/or 175b. System 100 may further include UI 130c and/or 130d that may be presented or displayed within corresponding UX platform system 130a and/or 130b.

In examples, system 100 may further include one or more overlay services or overlay services system 180, which may include at least one of one or more SASE services or SASE-based network services 185 or one or more other services 190. System 100 may further include a SASE system or the one or more SASE-based network services 185, the one or more SASE-based network services 180 collectively including a set of unified, cloud-based services that integrate software-defined wide area network (“SDWAN”) functionalities with network service functionalities and network security functionalities. In some embodiments, the SASE system or the one or more SASE-based network services 185 may include, without limitation, one or more SASE scriptlets, each SASE scriptlet being a software code that when executed is used to perform at least one specific SASE-based network function among a plurality of SASE-based network functions 190a, as described in detail with respect to U.S. Patent Application Ser. No. 63/496,787 (the “'787 Application”), filed Apr. 18, 2023, by Mark Alan Ramach et al. (attorney docket no. 1756-US-P1), entitled, “Secure Access Service Edge (SASE) Scriptlets for Providing SASE-Based Network Services,” the disclosure of which is incorporated herein by reference in its entirety for all purposes. In some embodiments, system 100 may further include one or more third parties 195, each with corresponding third party server(s) 195a and corresponding database(s) 195b. The one or more third parties 195 may provide software applications, SASE scriptlets, or other services for customers to purchase or manage on at least one of UX platform system 130a and/or 130b, and/or customer portal 140a and/or 140b.

In some embodiments, the computing system 105 may include, without limitation, at least one of a UX platform computing system, a customer interface server, a network service reservation and ordering platform server, a server computer, a gateway controller, a network provisioning server, a cloud computing system, or a distributed computing system, and/or the like. In some cases, the one or more user devices 155a-155l may each include, but is not limited to, one of a desktop computer, a laptop computer, a tablet computer, a smart phone, or a mobile phone, and/or the like. In some instances, the one or more network devices 160a-160m may each include, without limitation, one of a customer premises equipment (“CPE”), a universal CPE (“uCPE”), a server, a network node, or a network edge device, or the like. In some examples, the one or more user devices 155 and/or the one or more network devices 160 may each further include, but is not limited to, any suitable device capable of communicating with one or more of computing system 105, UX platform 130a or 130b, customer portal 140a or 140b, edge node(s) 170, and/or overlay services system 180, or the like, via a web-based portal, an API, a server, an app, or any other suitable communications interface, or the like, over network(s) 175a and/or 175b via gateway device 165, and the like, and/or any suitable device capable of running, executing, or implementing visualization for network services and their relationships with end-users, service locations, and other network services, and the like. In some instances, the locations 150a-150n may each include, without limitation, at least one of a customer premises, a residential customer premises, a business customer premises, a corporate customer premises, an enterprise customer premises, an education facility customer premises, a medical facility customer premises, a governmental customer premises, a business facility, a corporate facility, an enterprise facility, an education facility, a medical facility, or a governmental facility, and/or the like.

In some examples, the one or more SASE services 185 may include SASE network functions 185a including at least one of a plurality of network service software applications (“apps”), one or more Internet services, one or more wide area network (“WAN”) services, one or more SDWAN services, one or more network security services, one or more telephony services, one or more voice over Internet Protocol (“VoIP”) services, or other network services, and/or the like. In examples, the network service functionalities may include at least one of WAN optimization functionalities, software-defined application-centric network control functionalities, data loss prevention (“DLP”) functionalities, application performance management (“APM”) functionalities, bandwidth aggregation functionalities, network as a service (“NaaS”) functionalities, global private network functionalities, software as a service (“SaaS”) functionalities, content distribution network (“CDN”) functionalities, or multi-cloud networking functionalities, and/or the like. In some examples, the network security functionalities may include at least one of firewall (“FW”) functionalities, firewall as a service (“FWaaS”) functionalities, secure web gateway (“SWG”) functionalities, zero-trust network access (“ZTNA”) functionalities, anti-malware functionalities, intrusion detection functionalities, intrusion prevention functionalities, rapid threat defense (“RTD”) security functionality, cloud access security broker (“CASB”) functionalities, remote browser isolation (“RBI”) functionalities, web application and application programming interface (“API”) protection (“WAAP”) functionalities, secure sockets layer (“SSL”) or transport layer security (“TLS”) inspection functionalities, or network-based threat detection functionalities, and/or the like. In examples, other services 190 may include network functions 190a.

In various embodiments, the one or more SASE-based network services utilize SDWAN functionalities to achieve optimal WAN management by providing optimized network routing, optimized WAN and network security, optimized network connectivity, and optimized remote network access, in some cases, by using the software-defined nature of SDWAN, which allows for immediate, real-time or near-real-time, changes in configuration of the SDWAN without need for truck rolls or deployment of technicians, or the like. In some instances, FWaaS functionalities provide customized or customizable deployment of firewalls, thereby providing scalability and elasticity, while extending full network security throughout the network and/or to locations within the network as needed. In some cases, SWG functionalities may include, but are not limited to, filtering unwanted software or malware from user-initiated network traffic and enforcing corporate and regulatory policy compliance, and/or the like, in some cases, by utilizing at least one of uniform resource locator (“URL”) filtering, malicious-code detection and filtering, application controls for popular Web-based applications (e.g., instant messaging (“IM”) and Skype, or the like), native data leak prevention, or integrated data leak prevention, and/or the like.

In some instances, ZTNA functionalities enable dynamic adjustment of application or network service access by requiring verification of users' identities and establishment of device trust before providing users with access to authorized applications and/or network services, thereby preventing unauthorized access, containing potential breaches, and/or limiting lateral access within the network by malicious entities, and/or the like. In some instances, ZTNA functionalities may be based on such factors as user identity, location, device type, and/or the like. In some cases, CASB functionalities utilize either on-premises or cloud-based security policy enforcement points that are located between the users and network service providers, and are configured to combine and interject security policies (e.g., enterprise security policies) as network-based or cloud-based resources are accessed by the users. CASB functionalities may include consolidating multiple types of security policy enforcement, including, but not limited to, at least one of authentication, single sign-on, authorization, credential mapping, device profiling, encryption, tokenization, logging, alerting, malware detection, or malware prevention, and/or the like.

The one or more SASE-based network services—which are elastic, self-healing, and self-maintaining, and/or the like—may utilize unified management of these and other disparate network-based services, products, and/or functionalities, thereby enabling users to monitor and manage all network and security solutions from a single interface or portal (sometimes referred to as “a single pane of glass” or the like), in contrast with the traditionally delivered siloed point solutions that fail to integrate the disparate network and security solutions. In this manner, cost and complexity (in terms of network and security) may be reduced, centralized orchestration and real-time application optimization may be achieved, seamless access (including more secure remote and mobile access) for users may be provided, access may be restricted based on user, device, and/or application identity, consistent security policy may be applied to improve overall network security, and/or centralized management may be used to increase effectiveness of network and security staff, and/or the like.

According to some embodiments, network(s) 175a and/or 175b may each include, without limitation, one of a local area network (“LAN”), including, without limitation, a fiber network, an Ethernet network, a Token-Ring™ network, and/or the like; a WAN; a wireless wide area network (“WWAN”); a virtual network, such as a virtual private network (“VPN”); the Internet; an intranet; an extranet; a public switched telephone network (“PSTN”); an infra-red network; a wireless network, including, without limitation, a network operating under any of the IEEE 802.11 suite of protocols, the Bluetooth™ protocol known in the art, and/or any other wireless protocol; and/or any combination of these and/or other networks. In a particular embodiment, the network(s) 175a and/or 175b may include an access network of the service provider (e.g., an Internet service provider (“ISP”)). In another embodiment, the network(s) 175a and/or 175b may include a core network of the service provider and/or the Internet.

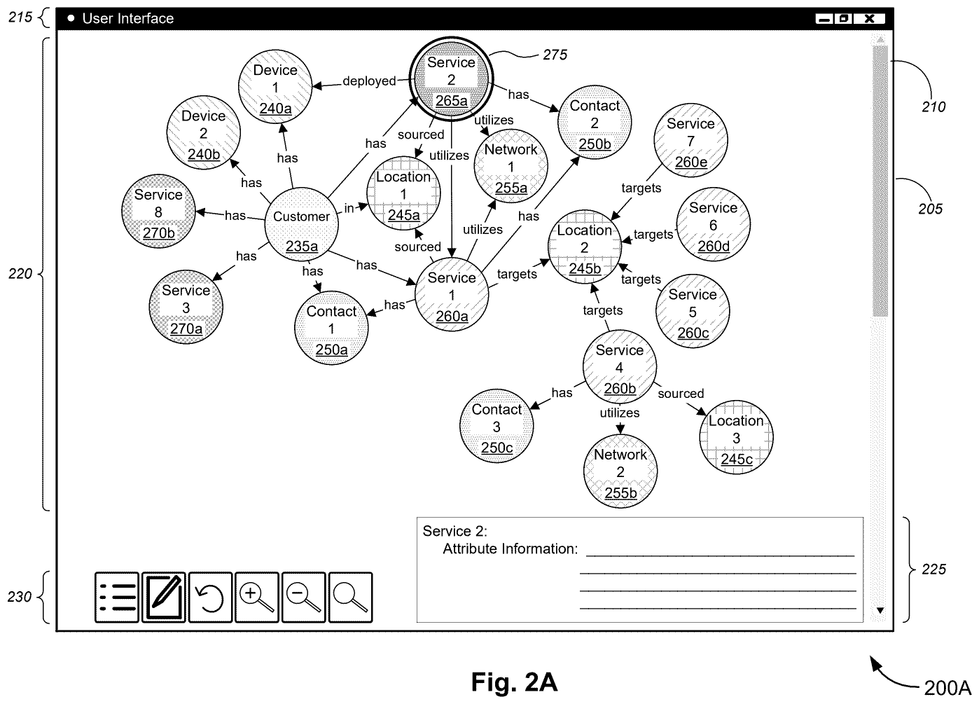

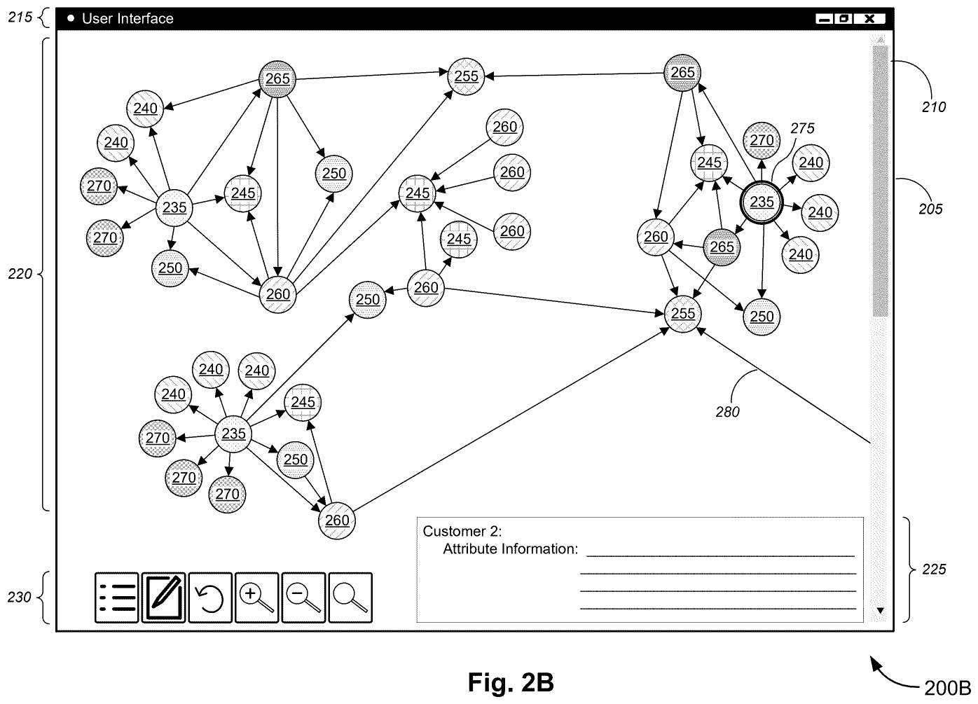

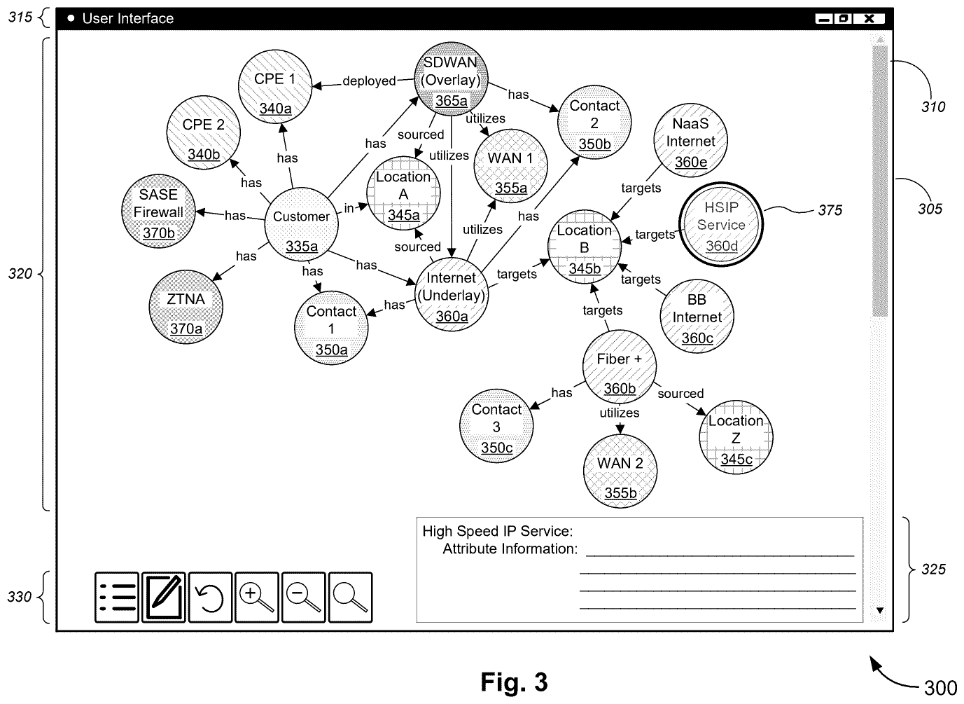

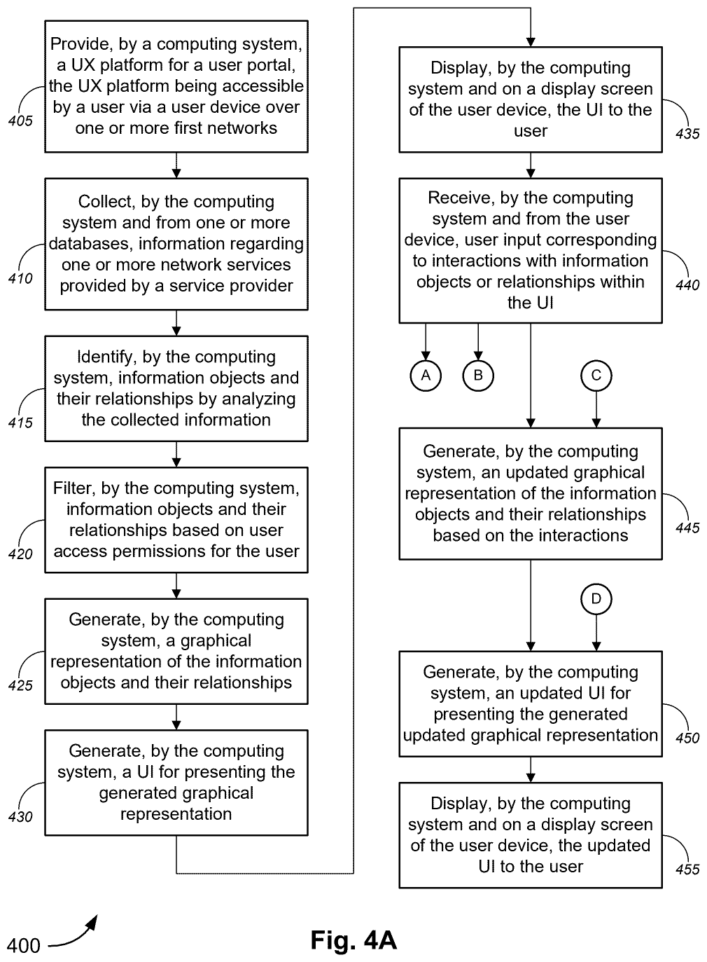

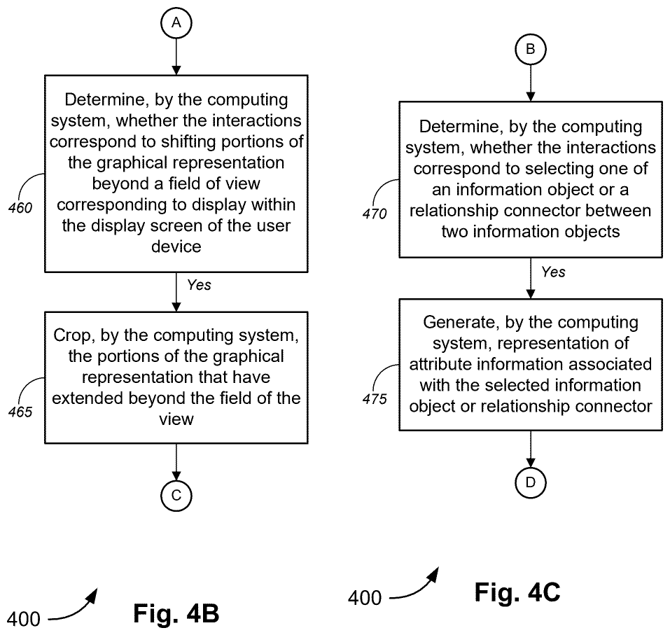

In operation, the computing system 105, UX platform 130a and/or 130b, UI generator 135a and/or 135b, and/or customer portal 140a and/or 140b (collectively, “computing system” or the like) may perform methods for implementing visualization for network services and their relationships with end-users, service locations, and other network services, also presented or displayed in a single interface or portal, as described in detail with respect to FIGS. 2-4. For example, example UIs 200A, 200B, and 300 as described below with respect to FIGS. 2A, 2B, and 3, and example method as described below with respect to FIGS. 4A-4C may be applied with respect to the operations of system 100 of FIG. 1.

FIGS. 2A and 2B (collectively, “Fig. 2”) depict various example user interfaces 200A and 200B for a user portal or a UX platform that may be used when implementing visualization for network services and their relationships with end-users, service locations, and other network services, in accordance with various embodiments.

The embodiment as represented in FIG. 2 is merely illustrative and is not intended to limit the scope of the various embodiments. In addition, any suitable user device—including, but not limited to, user device(s) 155, which may each include, but is not limited to, one of a desktop computer, a laptop computer, a tablet computer, a smart phone, or a mobile phone, or any suitable device capable of communicating with computing system 105, UX platform 130a or 130b, customer portal 140a or 140b, edge node 170, and/or overlay services system 180, or the like, via a web-based portal, an API, a server, an app, or any other suitable communications interface, or the like, over network(s) 175a and/or 175b of FIG. 1, and the like—may be used to display or present the user interfaces of FIG. 2.

As shown in the embodiment of FIG. 2, display or display screen 205 (which may be a touchscreen display or a non-touchscreen display) may display or present an app, an application window, program window or portal (e.g., web portal or the like) (collectively, “app or portal 210” or the like). In the non-limiting example of FIG. 2, the app or portal 210 running on the user device may be a user interface illustrating a UX platform manager or dashboard, or the like (in some cases, including “User Interface” or the like), although the various embodiments are not limited to such an app or portal, as described herein, and can be any suitable app or portal. The app or portal 210 displayed in display 205 may provide a user (e.g., a technician, a service provider agent, or other representative, etc. of the service provider, and/or a customer, a user (e.g., the user(s) as described above with respect to FIG. 1, or the like), or an agent of an entity, etc.) with the ability, functionality, or options to view a visualization for network services and their relationships with end-users, service locations, and other network services (such as described in detail with respect to FIGS. 1, 3, and 4A-4C, or the like).

As shown in the non-limiting example of FIGS. 2A and 2B, the app or portal 210 may include, without limitation, at least one of a header portion 215 (e.g., indicating the app or portal site as “User Interface” or the like), a network services visualization portion 220 (including icons of information objects and connectors between information objects representing their relationships), a description portion 225, and/or display control icons or buttons 230, and/or the like. In some examples, such as shown, e.g., in FIG. 2, the icons of the information objects may include icons of nodes, and although circular icons are shown in FIG. 2, the various embodiments are not so limited, and any suitable shape or size of icons may be used to represent nodes or other discrete object or subject that may be displayed in the visualization, including, but not limited to, triangular icons, square-shaped icons, rectangular icons, pentagonal icons, hexagonal icons, heptagonal icons, octagonal icons, other polygonal icons, irregular shaped icons, and/or any combination of these icons. As described below, the visualization enables zooming functionality, and thus size of the icons of the information objects as displayed may be changed by changing the level of zoom. While single-headed arrows are used to depict connectors representing relationships between icons of information objects, the various embodiments are not so limited, and any suitable connector may be used, including, line connectors (e.g., solid line connectors, dashed line connectors, etc.), double-headed arrows, block arrows, rectangular connectors, other polygonal connectors, irregular shaped connectors, and/or any combination of these connectors. In some cases, text of the relationship between the information objects may be overlaid over the depiction of the connectors (e.g., “has” possessive relationship, “in” descriptive relationship, and “sourced,” “deployed,” “targets,” or “utilizes” action relationship, or the like).

In the non-limiting example 200A of FIG. 2A, the information objects that are depicted as nodes may include at least one of customer 235a, devices 1 and 2 240a and 240b, locations 1-3 245a-245c, contacts 1-3 250a-250c, networks 1 and 2 255a and 255b, underlay services 1 and 4-7 260a-260e, overlay service 2 265a, and other services 3 and 8 270a and 270b, and/or the like. These information objects may be related to each other based on possessive relationships, descriptive relationships, and/or action relationships. For example, the customer 235a possesses (e.g., “has”) devices 1 and 2 240a and 240b, as well as underlay service 1 260a, overlay service 2 265a, other service 3 270a, other service 8 270b, and contact 1 250a. The customer 235a is described as being “in” location 1 245a. In an example, underlay service 1 260a possesses (e.g., “has”) contacts 1 and 2 250a and 250b, is sourced at location 1 245a, targets location 2 245b, utilizes network 1 255a, is utilized by service 2 265a, and is possessed by customer 235a. In examples, overlay service 2 265a is deployed on device 1 240a, is sourced at location 1 245a, possesses (e.g., “has”) contact 2 250b, utilizes network 1 255a, utilizes service 1 260a, and is possessed by customer 235a. In examples, underlay services 1 and 4-7 260a-260e each targets location 2 245b, where service 4 260b additionally possesses (e.g., “has”) contact 3 250c, utilizes network 2 255b, and is sourced at location 3 245c. Herein, “underlay service” may refer to a network service or network path (e.g., Internet service, IP VPN, etc.) that provides the network connections that enable network communications as well as other network services. On the other hand, “overlay service” may refer to a network service (e.g., SDWAN service, traffic management, SASE services, security policy managers, etc.) that is provided over the underlay service to provide additional or extended network services, while “other service” may refer to other network services (e.g., firewall service, etc.) that may be provided over the underlay and/or overlay service(s), or the like.

In some examples, when an icon of an information object or a relationship between information objects is selected (as shown, e.g., by circular outline 275 around service 2 265a (in FIG. 2A) or around customer 2 235 (in FIG. 2B)), attribute information for the selected information object or relationship may be displayed in the description portion 225, which may be displayed as one of a floating text box, a text field within a textual portion of the UI, a graphical icon representing the attribute information, a graphical icon containing the attribute information, a tab within a tab-filled window portion of the updated UI, or a pop-up window, and/or the like. The description portion 225 as depicted in FIG. 2A, for instance, is one of a floating text box, a text field within a textual portion of the UI, or a pop-up window, or the like. In general, attribute information may include gateway IP addresses, upload speed, download speed, latency, packet size, physical addresses of locations, contact information for individuals or agents, or relationships with other nodes or information objects, and/or the like. For ease of illustration, the description text is denoted in FIGS. 2A and 2B by long parallel lines, but in operation would be filled with alphanumeric and/or symbolic characters that describe the attributes of selected information objects, in this case, service 2 265a (e.g., upload speed, download speed, latency, and/or like, etc.) and customer 2 235 (e.g., name, service address, billing address, services ordered, services provisioned, ticket history, etc.) as shown in FIGS. 2A and 2B, respectively.

In some cases, the app or portal 210 may also display control icons or buttons 230, including buttons (typically, soft buttons or the like) for accessing menu options; for editing or annotating mapped relationships and/or options for particular or selected icons, relationships, hardware/network resources, and/or the like; for undoing changes; for zooming in; for zooming out; or for searching for particular information objects, relationships, hardware/network resources, etc.; and/or the like. Other user interactions may be implemented using touch or gesture input, keyboard input, etc., and may include inputs for at least one of: (a) zooming in within the UI to focus in on particular identified information objects and their corresponding relationships; (b) zooming out within the UI to view the larger interconnectedness of the information objects and their corresponding relationships; (c) rotating the graphical representation within the UI; (d) changing perspectives of the graphical representation of the information objects and their relationships as displayed within the UI; (e) separating one object from adjacent objects displayed within the graphical representation; (f) selecting an information object; (g) selecting a relationship between two information objects; or (h) displaying attributes of an object displayed within the graphical representation; and/or the like

Based on user access permissions, portions of the visualization (e.g., particular information objects, their relationships, corresponding attribute information, etc.) may be filtered or hidden. For example, a technician or NOC engineer of the service provider may be provided with access to all the network related information objects and their relationships across multiple customers and networks, but information (particularly, personal information) of the customers (aside from an address(es) where services are to be deployed, etc.) may be filtered or hidden. Similarly, a call agent of the service provider may be provided with access to customer information and customer services (except for personal information not related to resolving customer service issues), with information regarding other networks or other customers being filtered or hidden when communicating and assisting a particular customer. Likewise, a customer may be provided with network services and customer information related to the network services, with information regarding other networks or other customers being filtered or hidden. Third party providers may be provided with information regarding networks and/or services with which they are associated, with information regarding other networks, other customers, and other information (not related to the particular third party providers) being filtered or hidden. For instance, FIGS. 2A and 2B each depicts a visualization that may be accessible to a technician or NOC engineer, as each depicts network services 260, 265, and 270 across multiple networks 255 and locations 245. In the case of FIG. 2B, the depicted visualization covers multiple customers.

Referring to FIG. 2B, the visualization shown depicts a zoomed out view where the UI generator has cropped portions, as denoted by arrow 280 that extends beyond the field of view of the screen where the rest of the arrow 280 and the information objects directly or indirectly connected by the arrow 280 are cropped or hidden. As the visualization is interacted with, it may be rotated in view, the icons of the information objects and/or the relationship connectors may automatically be shifted, icons may be grouped together or separated from each other automatically, and/or textual indicators of the relationships may appear or disappear (e.g., based on zoom level or clutter level of the display, etc.). Although not shown, groupings may include overlapping of icons of the information objects or relationship connectors, or the like.

These and other features of the UI and visualization may be described in greater detail with respect to FIGS. 1, 3, and 4.

FIG. 3 depicts an example user interface 300 for a user portal or a UX platform that may be used when implementing visualization for network services (including SASE services) and their relationships with end-users, service locations, and other network services, in accordance with various embodiments. In some embodiments, display or display screen 305, app or portal 310, header portion 315, network services visualization portion 320, description portion 325, and display control icons or buttons 330 of FIG. 3 may be similar, if not identical, to the display or display screen 205, app or portal 210, header portion 215, network services visualization portion 220, description portion 225, and display control icons or buttons 230, respectively, of example UIs 200A or 200B of FIG. 2A or 2B, respectively, and the description of these components of UIs 200A or 200B of FIG. 2A or 2B are similarly applicable to the corresponding components of example UI 300 FIG. 3.

Where example UIs 200A and 200B depict general network services, example UI 300 depicts examples of components utilizing SASE services including at least one of a plurality of network service apps, one or more Internet services, one or more WAN services, one or more SDWAN services, one or more network security services, one or more telephony services, one or more VoIP services, or other network services, and/or the like. In examples, the network service functionalities may include at least one of WAN optimization functionalities, software-defined application-centric network control functionalities, DLP functionalities, APM functionalities, bandwidth aggregation functionalities, NaaS functionalities, global private network functionalities, SaaS functionalities, CDN functionalities, or multi-cloud networking functionalities, and/or the like. In some examples, the network security functionalities may include at least one of FW functionalities, FWaaS functionalities, SWG functionalities, ZTNA functionalities, anti-malware functionalities, intrusion detection functionalities, intrusion prevention functionalities, RTD security functionality, CASB functionalities, RBI functionalities, WAAP functionalities, SSL or TLS inspection functionalities, or network-based threat detection functionalities, and/or the like.

In the non-limiting example 300A of FIG. 3A, the information objects that are depicted as nodes may include at least one of customer 335a, customer premises equipment (“CPEs”) 1 and 2 340a and 340b, locations A, B, and Z 345a-345c, contacts 1-3 350a-350c, WAN services 1 and 2 355a and 355b, Internet (underlay) service 360a, fiber+service 360b, broadband (“BB”) Internet service 360c, high speed IP (“HSIP”) service 360d, network as a service (“NaaS”) Internet service 360e, SDWAN (overlay) service 365a, ZTNA service 370a, and SASE firewall service 370b, and/or the like. These information objects may be related to each other based on possessive relationships, descriptive relationships, and/or action relationships. For example, the customer 335a possesses (e.g., “has”) CPEs 1 and 2 340a and 340b, as well as Internet (underlay) service 360a, SDWAN (overlay) service 365a, ZTNA service 370a, and SASE firewall service 370b, and contact 1 350a. The customer 335a is described as being “in” location A 345a. In an example, Internet (underlay) service 360a possesses (e.g., “has”) contacts 1 and 2 350a and 350b, is sourced at location A 345a, targets location B 345b, utilizes WAN service 1 355a, is utilized by SDWAN (overlay) service 365a, and is possessed by customer 335a. In examples, SDWAN (overlay) service 365a is deployed on CPE 1 340a, is sourced at location A 345a, possesses (e.g., “has”) contact 2 350b, utilizes WAN service 1 355a, utilizes Internet (underlay) service 360a, and is possessed by customer 335a. In examples, Internet (underlay) service 360a, fiber+ service 360b, BB Internet service 360c, HSIP service 360d, and NaaS Internet service 360e each targets location B 345b, where fiber+ service 360b additionally possesses (e.g., “has”) contact 3 350c, utilizes WAN service 2 355b, and is sourced at location Z 345c. As shown in FIG. 3, when HSIP service 360d is selected (as depicted by circular outline 375), attribute information for this information object may be displayed in description potion 325. For ease of illustration, the description text is denoted by long parallel lines, but in operation would be filled with alphanumeric and/or symbolic characters that describe the attributes of selected information objects, in this case, HSIP service 360d (e.g., speed, latency, and/or packet size, etc.) as shown in FIG. 3.

FIGS. 4A-4C (collectively, “FIG. 4”) depict flow diagrams illustrating an example method 400 for implementing visualization for network services and their relationships with end-users, service locations, and other network services, in accordance with various embodiments. Method 400 of FIG. 4A either continues onto FIG. 4B following the circular marker denoted, “A,” and returns to FIG. 4A following the circular marker denoted, “C,” or continues onto FIG. 4C following the circular marker denoted, “B,” and returns to FIG. 4A following the circular marker denoted, “D.”

While the techniques and procedures are depicted and/or described in a certain order for purposes of illustration, it should be appreciated that certain procedures may be reordered and/or omitted within the scope of various embodiments. Moreover, while the method 400 illustrated by FIG. 4 can be implemented by or with (and, in some cases, are described below with respect to) the systems, examples, or embodiments 100, 200A, 200B, and 300 of FIGS. 1, 2A, 2B, and 3, respectively (or components thereof), such methods may also be implemented using any suitable hardware (or software) implementation. Similarly, while each of the systems, examples, or embodiments 100, 200A, 200B, and 300 of FIGS. 1, 2A, 2B, and 3, respectively (or components thereof), can operate according to the method 400 illustrated by FIG. 4 (e.g., by executing instructions embodied on a computer readable medium), the systems, examples, or embodiments 100, 200A, 200B, and 300 of FIGS. 1, 2A, 2B, and 3 can each also operate according to other modes of operation and/or perform other suitable procedures.

In the non-limiting embodiment of FIG. 4A, method 400, at operation 405, may include providing, by a computing system, a user experience (“UX”) platform (e.g., UX platform 130a or 130b of FIG. 1, or the like) for a user portal (e.g., customer portal 140a or 140b of FIG. 1, or the like). The UX platform is accessible by a user via a user device (e.g., user devices 150a-150l or network devices 155a-155m of FIG. 1, or the like) over one or more first networks (e.g., networks 175a and/or 175b of FIG. 1, or the like). At operation 410, method 400 may include collecting, by the computing system, and from one or more databases (e.g., database(s) 110 of FIG. 1, or the like), information regarding one or more network services provided by a service provider (e.g., service provider 145 of FIG. 1, or the like). Method 400 may further include, at operation 415, identifying, by the computing system, information objects and their relationships by analyzing the collected information (from operation 410).

In examples, the computing system includes at least one of a UX platform computing system, a customer interface server, a network service reservation and ordering platform server, a server computer, a gateway controller, a network provisioning server, a cloud computing system, or a distributed computing system, and/or the like. In some instances, the user includes one of a customer of the service provider, a call agent of service provider, a technician of the service provider, a NOC engineer, an agent of a third party network provider, an agent of a third party service provider, and/or the like. In some cases, each of the third party network provider and the third party service provider is separate from the service provider providing the one or more network services. In an example, the service provider providing the network services and the service provider that provides the UX platform are the same service provider. In another example, the service provider providing the network services and the service provider that provides the UX platform are different service providers. In some examples, the information includes at least one of end-user information, service-specific information, service location information, or contact information, and/or the like.

In some examples, the one or more network services may include SASE services including at least one of a plurality of network service apps, one or more Internet services, one or more WAN services, one or more SDWAN services, one or more network security services, one or more telephony services, one or more VoIP services, or other network services, and/or the like. In examples, the network service functionalities may include at least one of WAN optimization functionalities, software-defined application-centric network control functionalities, DLP functionalities, APM functionalities, bandwidth aggregation functionalities, NaaS functionalities, global private network functionalities, SaaS functionalities, CDN functionalities, or multi-cloud networking functionalities, and/or the like. In some examples, the network security functionalities may include at least one of FW functionalities, FWaaS functionalities, SWG functionalities, ZTNA functionalities, anti-malware functionalities, intrusion detection functionalities, intrusion prevention functionalities, RTD security functionality, CASB functionalities, RBI functionalities, WAAP functionalities, SSL or TLS inspection functionalities, or network-based threat detection functionalities, and/or the like.

In some examples, method 400 may further include filtering, by the computing system, information objects and their relationships based on user access permissions for the user (at operation 420). For example, a technician or NOC engineer of the service provider may be provided with access to all the network related information objects and their relationships across multiple customers and networks, but information (particularly, personal information) of the customers (aside from address where services are to be deployed, etc.) may be filtered or hidden. Similarly, a call agent of the service provider may be provided with access to customer information and customer services (except for personal information not related to resolving customer service issues), with information regarding other networks or other customers being filtered or hidden when communicating and assisting a particular customer. Likewise, a customer may be provided with network services and customer information related to the network services, with information regarding other networks or other customers being filtered or hidden. Third party providers may be provided with information regarding networks and/or services with which they are associated, with information regarding other networks, other customers, and other information (not related to the particular third party providers) being filtered or hidden.

At operation 425, method 400 may include generating, by the computing system, a graphical representation of the information objects and their relationships. In some examples, generating the graphical representation of the identified information objects and the identified relationships is performed in view of the filtering (at operation 420). In examples, filtered information objects and their relationships may be at least one of removed from the graphical representation, visually hidden within the graphical representation, grayed out within the graphical representation, unselectable within the graphical representation, or locked from providing attribute information when selection is attempted, and/or the like.

Method 400, at operation 430, may include generating, by the computing system, a UI for presenting the generated graphical representation. Method 400 may further include displaying, by the computing system and on a display screen of the user device, the UI to the user (at operation 435). In some instances, displaying the UI (at operation 435) comprises displaying the UI within the UX platform.

At operation 440, method 400 may include receiving, by the computing system and from the user device, user input corresponding to interactions with at least one of one or more information objects or one or more relationships within the generated and displayed UI. Method 400 either may continue onto the process at operation 445, may continue onto the process at operation 460 in FIG. 4B following the circular marker denoted, “A” (and returns to the operation 445 in FIG. 4A following the circular marker denoted, “C”), and/or may continue onto the process at operation 470 in FIG. 4C following the circular marker denoted, “B” (and returns to the operation 450 in FIG. 4A following the circular marker denoted, “D”). At operation 445, method 400 may include generating, by the computing system, an updated graphical representation of the information objects and their relationships based on the interactions. At operation 450, method 400 may include generating, by the computing system, an updated UI for presenting the generated updated graphical representation. At operation 455, method 400 may include displaying, by the computing system and on the display screen of the user device, the updated UI to the user.

At operation 460 in FIG. 4B (following the circular marker denoted, “A,” in FIG. 4A), method 400 may include determining, by the computing system, whether the interactions correspond to shifting portions of the graphical representation beyond a field of view corresponding to display within the display screen of the user device. Based on a determination that the interactions correspond to shifting portions of the graphical representation, method 400 includes cropping, by the computing system, the portions of the graphical representation that have extended beyond the field of the view (at operation 465). Method 400 returns to the operation 445 in FIG. 4A following the circular marker denoted, “C.” In such examples, generating the updated graphical representation (at operation 445) is further based on the cropping of the portions of the graphical representation that have extended beyond the field of the view (at operation 465). In examples, generating the updated UI (at operation 450) and displaying the updated UI (at operation 455) are based on the updated graphical representation (at operation 445) that is further based on the cropping of the portions of the graphical representation that have extended beyond the field of the view (at operation 465).

At operation 470 in FIG. 4C (following the circular marker denoted, “B,” in FIG. 4A), method 400 may include determining, by the computing system, whether the interactions correspond to selecting one of an information object or a relationship connector between two information objects. Based on a determination that the interactions correspond to selecting the one of the information object or the relationship connector between two information objects, generating, by the computing system, representation of attribute information associated with the selected information object or relationship connector (at operation 475). Method 400 returns to the operation 450 in FIG. 4A following the circular marker denoted, “D.” In such examples, generating the updated graphical representation (at operation 445) is further based on the generated representation of attribute information (at operation 475). In examples, generating the updated UI (at operation 450) and displaying the updated UI (at operation 455) are based on the updated graphical representation (at operation 445) that is further based on the generated representation of attribute information (at operation 475). In some examples, the attribute information may be displayed as one of a floating text box, a text field within a textual portion of the updated UI, a graphical icon representing the attribute information, a graphical icon containing the attribute information, a tab within a tab-filled window portion of the updated UI, or a pop-up window, and/or the like.

In examples, the interactions may include at least one of zooming in within the UI to focus in on particular identified information objects and their corresponding relationships; zooming out within the UI to view the larger interconnectedness of the information objects and their corresponding relationships; rotating the graphical representation within the UI; changing perspectives of the graphical representation of the information objects and their relationships as displayed within the UI; separating one object from adjacent objects displayed within the graphical representation; selecting an information object; selecting a relationship between two information objects; or displaying attributes of an object displayed within the graphical representation; and/or the like.

### Exemplary System and Hardware Implementation

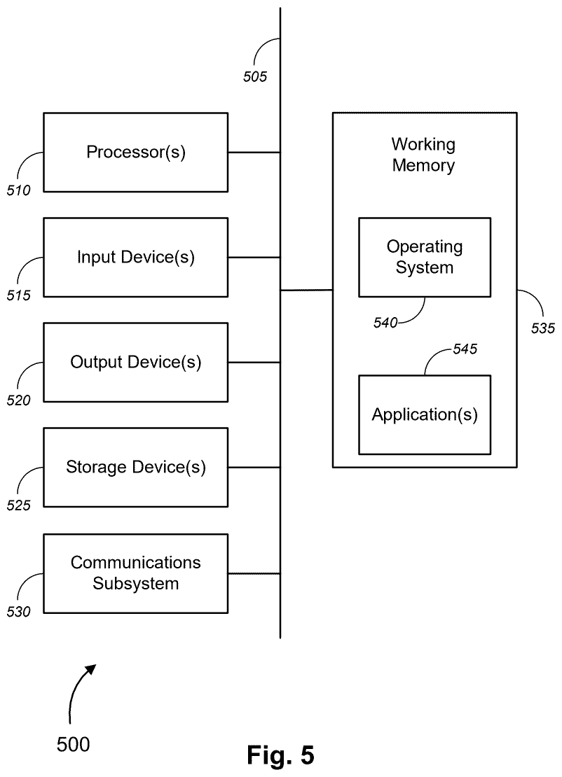

FIG. 5 is a block diagram illustrating an exemplary computer or system hardware architecture, in accordance with various embodiments. FIG. 5 provides a schematic illustration of one embodiment of a computer system 500 of the service provider system hardware that can perform the methods provided by various other embodiments, as described herein, and/or can perform the functions of computer or hardware system (i.e., computing system 105, network service monitoring system 115a or 115b, IT platform services system 120, network service provisioning system 125, UX platform 130a or 130b, UI generator 135a or 135b, UI 135c, customer portal 140a or 140b, user devices 155a-155l, network devices 160a-160m, gateway devices 165a-165n, edge nodes 170, etc.), as described above. It should be noted that FIG. 5 is meant only to provide a generalized illustration of various components, of which one or more (or none) of each may be utilized as appropriate. FIG. 5, therefore, broadly illustrates how individual system elements may be implemented in a relatively separated or relatively more integrated manner.

The computer or hardware system 500—which may represent an embodiment of the computer or hardware system (i.e., computing system 105, network service monitoring system 115a or 115b, IT platform services system 120, network service provisioning system 125, UX platform 130a or 130b, UI generator 135a or 135b, UI 135c, customer portal 140a or 140b, user devices 155a-155l, network devices 160a-160m, gateway devices 165a-165n, edge nodes 170, etc.), described above with respect to FIGS. 1-4—is shown including hardware elements that can be electrically coupled via a bus 505 (or may otherwise be in communication, as appropriate). The hardware elements may include one or more processors 510, including, without limitation, one or more general-purpose processors and/or one or more special-purpose processors (such as microprocessors, digital signal processing chips, graphics acceleration processors, and/or the like); one or more input devices 515, which can include, without limitation, a mouse, a keyboard, and/or the like; and one or more output devices 520, which can include, without limitation, a display device, a printer, and/or the like.

The computer or hardware system 500 may further include (and/or be in communication with) one or more storage devices 525, which can include, without limitation, local and/or network accessible storage, and/or can include, without limitation, a disk drive, a drive array, an optical storage device, solid-state storage device such as a random access memory (“RAM”) and/or a read-only memory (“ROM”), which can be programmable, flash-updateable, and/or the like. Such storage devices may be configured to implement any appropriate data stores, including, without limitation, various file systems, database structures, and/or the like.

The computer or hardware system 500 may also include a communications subsystem 530, which can include, without limitation, a modem, a network card (wireless or wired), an infra-red communication device, a wireless communication device and/or chipset (such as a Bluetooth™M device, an 802.11 device, a Wi-Fi device, a WiMAX device, a wireless wide area network (“WWAN”) device, cellular communication facilities, etc.), and/or the like. The communications subsystem 530 may permit data to be exchanged with a network (such as the network described below, to name one example), with other computer or hardware systems, and/or with any other devices described herein. In many embodiments, the computer or hardware system 500 will further include a working memory 535, which can include a RAM or ROM device, as described above.

The computer or hardware system 500 also may include software elements, shown as being currently located within the working memory 535, including an operating system 540, device drivers, executable libraries, and/or other code, such as one or more application programs 545, which may include computer programs provided by various embodiments (including, without limitation, hypervisors, virtual machines (“VMs”), and the like), and/or may be designed to implement methods, and/or configure systems, provided by other embodiments, as described herein. Merely by way of example, one or more procedures described with respect to the method(s) discussed above may be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code may be encoded and/or stored on a non-transitory computer readable storage medium, such as the storage device(s) 525 described above. In some cases, the storage medium may be incorporated within a computer system, such as the system 500. In other embodiments, the storage medium may be separate from a computer system (i.e., a removable medium, such as a compact disc, etc.), and/or provided in an installation package, such that the storage medium can be used to program, configure, and/or adapt a general purpose computer with the instructions/code stored thereon. These instructions may take the form of executable code, which is executable by the computer or hardware system 500 and/or may take the form of source and/or installable code, which, upon compilation and/or installation on the computer or hardware system 500 (e.g., using any of a variety of generally available compilers, installation programs, compression/decompression utilities, etc.) then takes the form of executable code.

It will be apparent to those skilled in the art that substantial variations may be made in accordance with specific requirements. For example, customized hardware (such as programmable logic controllers, field-programmable gate arrays, application-specific integrated circuits, and/or the like) may also be used, and/or particular elements may be implemented in hardware, software (including portable software, such as applets, etc.), or both. Further, connection to other computing devices such as network input/output devices may be employed.

As mentioned above, in one aspect, some embodiments may employ a computer or hardware system (such as the computer or hardware system 500) to perform methods in accordance with various embodiments of the invention. According to a set of embodiments, some or all of the procedures of such methods are performed by the computer or hardware system 500 in response to processor 510 executing one or more sequences of one or more instructions (which may be incorporated into the operating system 540 and/or other code, such as an application program 545) contained in the working memory 535. Such instructions may be read into the working memory 535 from another computer readable medium, such as one or more of the storage device(s) 525. Merely by way of example, execution of the sequences of instructions contained in the working memory 535 may cause the processor(s) 510 to perform one or more procedures of the methods described herein.

The terms “machine readable medium” and “computer readable medium,” as used herein, refer to any medium that participates in providing data that causes a machine to operate in a specific fashion. In an embodiment implemented using the computer or hardware system 500, various computer readable media may be involved in providing instructions/code to processor(s) 510 for execution and/or may be used to store and/or carry such instructions/code (e.g., as signals). In many implementations, a computer readable medium is a non-transitory, physical, and/or tangible storage medium. In some embodiments, a computer readable medium may take many forms, including, but not limited to, non-volatile media, volatile media, or the like. Non-volatile media includes, for example, optical and/or magnetic disks, such as the storage device(s) 525. Volatile media includes, without limitation, dynamic memory, such as the working memory 535. In some alternative embodiments, a computer readable medium may take the form of transmission media, which includes, without limitation, coaxial cables, copper wire, and fiber optics, including the wires that include the bus 505, as well as the various components of the communication subsystem 530 (and/or the media by which the communications subsystem 530 provides communication with other devices). In an alternative set of embodiments, transmission media can also take the form of waves (including without limitation radio, acoustic, and/or light waves, such as those generated during radio-wave and infra-red data communications).

Common forms of physical and/or tangible computer readable media include, for example, a floppy disk, a flexible disk, a hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read instructions and/or code.

Various forms of computer readable media may be involved in carrying one or more sequences of one or more instructions to the processor(s) 510 for execution. Merely by way of example, the instructions may initially be carried on a magnetic disk and/or optical disc of a remote computer. A remote computer may load the instructions into its dynamic memory and send the instructions as signals over a transmission medium to be received and/or executed by the computer or hardware system 500. These signals, which may be in the form of electromagnetic signals, acoustic signals, optical signals, and/or the like, are all examples of carrier waves on which instructions can be encoded, in accordance with various embodiments of the invention.

The communications subsystem 530 (and/or components thereof) generally will receive the signals, and the bus 505 then may carry the signals (and/or the data, instructions, etc. carried by the signals) to the working memory 535, from which the processor(s) 505 retrieves and executes the instructions. The instructions received by the working memory 535 may optionally be stored on a storage device 525 either before or after execution by the processor(s) 510.

While certain features and aspects have been described with respect to exemplary embodiments, one skilled in the art will recognize that numerous modifications are possible. For example, the methods and processes described herein may be implemented using hardware components, software components, and/or any combination thereof. Further, while various methods and processes described herein may be described with respect to particular structural and/or functional components for ease of description, methods provided by various embodiments are not limited to any particular structural and/or functional architecture but instead can be implemented on any suitable hardware, firmware and/or software configuration. Similarly, while certain functionality is ascribed to certain system components, unless the context dictates otherwise, this functionality can be distributed among various other system components in accordance with the several embodiments.

Moreover, while the procedures of the methods and processes described herein are described in a particular order for ease of description, unless the context dictates otherwise, various procedures may be reordered, added, and/or omitted in accordance with various embodiments. Moreover, the procedures described with respect to one method or process may be incorporated within other described methods or processes; likewise, system components described according to a particular structural architecture and/or with respect to one system may be organized in alternative structural architectures and/or incorporated within other described systems. Hence, while various embodiments are described with—or without—certain features for ease of description and to illustrate exemplary aspects of those embodiments, the various components and/or features described herein with respect to a particular embodiment can be substituted, added and/or subtracted from among other described embodiments, unless the context dictates otherwise. Consequently, although several exemplary embodiments are described above, it will be appreciated that the invention is intended to cover all modifications and equivalents within the scope of the following claims.

What is claimed is:

1. A method, comprising:
collecting, by a computing system and from one or more databases, information regarding one or more network services provided by a service provider, the information including at least one of end-user information, service-specific information, service location information, or contact information;
identifying, by the computing system, information objects and their relationships by analyzing the collected information;
generating, by the computing system, a graphical representation of the information objects and their relationships;
generating, by the computing system, a user interface (“UI”) for presenting the generated graphical representation; and
displaying, by the computing system and on a display screen of a user device, the UI to a user.

2. The method of claim 1, wherein the computing system comprises at least one of a user experience (“UX”) platform computing system, a customer interface server, a network service reservation and ordering platform server, a server computer, a gateway controller, a network provisioning server, a cloud computing system, or a distributed computing system.

3. The method of claim 1, wherein the user comprises one of a customer of the service provider, a call agent of service provider, a technician of the service provider, a network operations center (“NOC”) engineer, an agent of a third party network provider, an agent of a third party service provider, wherein each of the third party network provider and the third party service provider is separate from the service provider providing the one or more network services.

4. The method of claim 1, further comprising:
providing, by a computing system, a UX platform for a user portal, the UX platform being accessible by the user via the user device over one or more first networks;
wherein displaying the UI comprises displaying the UI within the UX platform.

5. The method of claim 1, further comprising:
filtering, by the computing system, information objects and their relationships based on user access permissions for the user;
wherein generating the graphical representation of the identified information objects and the identified relationships is performed in view of the filtering, wherein filtered information objects and their relationships are at least one of removed from the graphical representation, visually hidden within the graphical representation, grayed out within the graphical representation, unselectable within the graphical representation, or locked from providing attribute information when selection is attempted.

6. The method of claim 1, further comprising:
receiving, by the computing system and from the user device, user input corresponding to interactions with at least one of one or more information objects or one or more relationships within the generated and displayed UI;
generating, by the computing system, an updated graphical representation of the information objects and their relationships based on the interactions;
generating, by the computing system, an updated UI for presenting the generated updated graphical representation; and
displaying, by the computing system and on the display screen of the user device, the updated UI to the user.

7. The method of claim 6, further comprising:
determining, by the computing system, whether the interactions correspond to shifting portions of the graphical representation beyond a field of view corresponding to display within the display screen of the user device; and
based on a determination that the interactions correspond to shifting portions of the graphical representation beyond the field of view, further updating, by the computing system, the updated UI to crop the portions of the graphical representation that have extended beyond the field of the view, and displaying, by the computing system and on the display screen of the user device, the further updated UI to the user.

8. The method of claim 6, further comprising:
determining, by the computing system, whether the interactions correspond to selecting one of an information object or a relationship connector between two information objects; and
based on a determination that the interactions correspond to selecting one of an information object or a relationship connector between two information objects, further updating, by the computing system, the updated UI to display, within a portion of the updated UI, attribute information associated with the selected one of the information object or the relationship connector, wherein the attribute information is displayed as one of a floating text box, a text field within a textual portion of the updated UI, a graphical icon representing the attribute information, a graphical icon containing the attribute information, a tab within a tab-filled window portion of the updated UI, or a pop-up window.

9. The method of claim 6, wherein the interactions include at least one of:
zooming in within the UI to focus in on particular identified information objects and their corresponding relationships;
zooming out within the UI to view the larger interconnectedness of the information objects and their corresponding relationships;
rotating the graphical representation within the UI;
changing perspectives of the graphical representation of the information objects and their relationships as displayed within the UI;
separating one object from adjacent objects displayed within the graphical representation;
selecting an information object;
selecting a relationship between two information objects; or
displaying attributes of an object displayed within the graphical representation.

10. A system, comprising:
a computing system, comprising:
a processing system; and
memory coupled to the processing system, the memory comprising computer executable instructions that, when executed by the processing system, causes the system to perform operations comprising:
generating a graphical representation of information objects and their relationships based on analysis of collected information regarding one or more network services provided by a service provider, wherein the one or more network services include secure access service edge (“SASE”) services;
generating a user interface (“UI”) for presenting the generated graphical representation;
displaying, on a display screen of a user device, the UI to a user;
receiving user input from the user corresponding to interactions with at least one of one or more information objects or one or more relationships within the displayed UI;
generating an updated graphical representation of the information objects and their relationships based on the interactions;
generating an updated UI for presenting the generated updated graphical representation; and
displaying, on the display screen of the user device, the updated UI to the user.

11. The system of claim 10, wherein the computing system comprises at least one of a user experience (“UX”) platform computing system, a customer interface server, a network service reservation and ordering platform server, a server computer, a gateway controller, a network provisioning server, a cloud computing system, or a distributed computing system.

12. The system of claim 10, wherein the information including at least one of end-user information, service-specific information, service location information, or contact information.

13. The system of claim 10, wherein the operations further comprise:
collecting, from one or more databases, the information regarding the one or more network services provided by the service provider; and
identifying the information objects and their relationships by analyzing the collected information.

14. The system of claim 10, wherein the operations further comprise:
determining whether the interactions correspond to shifting portions of the graphical representation beyond a field of view corresponding to display within the display screen of the user device; and
based on a determination that the interactions correspond to shifting portions of the graphical representation beyond the field of view, further updating the updated UI to crop the portions of the graphical representation beyond the field of the view, and displaying, on the display screen of the user device, the further updated UI to the user.

15. The system of claim 10, wherein the operations further comprise:
determining whether the interactions correspond to selecting one of an information object or a relationship connector between two information objects; and
based on a determination that the interactions correspond to selecting one of an information object or a relationship connector between two information objects, further updating the updated UI to display, within a portion of the updated UI, attribute information associated with the selected one of the information object or the relationship connector.

16. The system of claim 15, wherein the attribute information is displayed as one of a floating text box, a text field within a textual portion of the updated UI, a graphical icon representing the attribute information, a graphical icon containing the attribute information, a tab within a tab-filled window portion of the updated UI, or a pop-up window.

17. A method, comprising:
providing, by a computing system, a user experience (“UX”) platform for a customer portal, the UX platform being accessible by a user via a user device over one or more first networks;
generating, by the computing system, a graphical representation of information objects and their relationships based on analysis of collected information regarding one or more network services provided by a service provider and further based on access permissions of the user;
generating, by the computing system, a user interface (“UI”) for presenting the generated graphical representation within the UX platform;
displaying, by the computing system and on a display screen of the user device, the UI to the user;
receiving, by the computing system and from the user device, user input corresponding to interactions with at least one of one or more information objects or one or more relationships within the generated and displayed UI;
generating, by the computing system, an updated graphical representation of the information objects and their relationships based on the interactions;
generating, by the computing system, an updated UI for presenting the generated updated graphical representation; and
displaying, by the computing system and on the display screen of the user device, the updated UI to the user.

18. The method of claim 17, wherein the computing system comprises at least one of a UX platform computing system, a customer interface server, a network service reservation and ordering platform server, a server computer, a gateway controller, a network provisioning server, a cloud computing system, or a distributed computing system.

19. The method of claim 17, further comprising:
determining, by the computing system, whether the interactions correspond to shifting portions of the graphical representation beyond a field of view corresponding to display within the display screen of the user device; and
based on a determination that the interactions correspond to shifting portions of the graphical representation beyond the field of view, further updating, by the computing system, the updated UI to crop the portions of the graphical representation beyond the field of the view, and displaying, by the computing system and on the display screen of the user device, the further updated UI to the user.

20. The method of claim 17, further comprising:
determining, by the computing system, whether the interactions correspond to selecting one of an information object or a relationship connector between two information objects; and
based on a determination that the interactions correspond to selecting one of an information object or a relationship connector between two information objects, further updating, by the computing system, the updated UI to display, within a portion of the updated UI, attribute information associated with the selected one of the information object or the relationship connector, wherein the attribute information is displayed as one of a floating text box, a text field within a textual portion of the updated UI, a graphical icon representing the attribute information, a graphical icon containing the attribute information, a tab within a tab-filled window portion of the updated UI, or a pop-up window.
